(19) United States
(12) Patent Application Publication
(10) Pub. No.: US 2015/0082882 A1
(43) Pub. Date: Mar. 26, 2015

(54) SYSTEM FOR DETERMINING THE LEVEL OF A LIQUID IN A CONTAINER

(71) Applicant: Joseph D. Antocci, Leominster, MA (US)

(72) Inventor: Joseph D. Antocci, Leominster, MA (US)

(21) Appl. No.: 14/498,079

(22) Filed: Sep. 26, 2014

Related U.S. Application Data
(60) Provisional application No. 61/882,968, filed on Sep. 26, 2013.

(51) Int. Cl. G01F 23/18; G01F 23/14

(52) U.S. Cl. CPC G01F 23/18; G01F 23/14
USPC 73/301

(57) ABSTRACT

A system for determining liquid level in containers. According to one embodiment, the system is configured for use with a single container. The system includes a tube having a distal branch and two proximal branches. The distal branch is sized to extend from inside the container to a remote location. One proximal branch is coupled to a pressure transducer for emitting a signal in response to the sensed fluid pressure head in the container, and the other proximal branch is coupled through a check valve to a gas displacement device used periodically to blow debris from the distal branch. A processor coupled to the transducer uses the fluid pressure head signal to determine the liquid level. A display coupled to the processor displays the determined liquid level. In another embodiment, the system may be used to determine the liquid level in any, some, or all of a plurality of containers.

### CROSS-REFERENCE TO RELATED APPLICATIONS

The present application claims the benefit under 35 U.S.C. 119(e) of U.S. Provisional Patent Application No. 61/882,968, filed Sep. 26, 2013, the disclosure of which is incorporated herein by reference.

### BACKGROUND OF THE INVENTION

The present invention relates generally to systems for determining the level of a liquid in a container and relates more particularly to a novel system for determining the level of a liquid in a container.

There are many situations in which it may be desirable to determine the level, i.e., quantity, of a liquid in a container. For example, the liquid in the container may be useful as a reactant or solvent in a chemical process, with volumes of the liquid periodically or continuously being withdrawn from the container to enable the chemical process to take place. Consequently, it may be desirable to know when the level of the liquid in the container falls below a predetermined threshold so that, for example, additional liquid may be added to the container or the container may be replaced with a container containing a greater quantity of liquid, thereby avoiding a disruption in the chemical process. In some cases, it may be possible to determine the level of a liquid in a container through some form of visual inspection, for example, by looking through the walls of the container or by looking through an opening in the container. However, in other cases, such a visual inspection may be undesirable or impractical, such as when the walls of the container may be too opaque to permit viewing the level of the liquid or when the container should not be opened and exposed to the ambient environment or vice versa. Moreover, a visual inspection may be inaccurate as it is dependent on the skill of the person performing the visual inspection. Furthermore, a visual inspection requires the physical presence of the person conducting the inspection in proximity to the container, which proximity may be dangerous or impractical.

For many of these reasons, a number of automated systems have been devised for determining the level of a liquid in a container. One such type of automated system involves the use of a pressure transducer that is submersible in the liquid and that is coupled through a cord to an externally-located control unit with a display. Such systems, however, cannot be used in certain hazardous or potentially hazardous environments where electrical current is not permitted. In addition, such systems typically do not take into account the specific gravity of the liquid in the container; consequently, a user must perform some type of conversion of the pressure reading to obtain a liquid level reading. Other types of automated systems involve the use of optical or mechanical sensors to detect liquid level. However, many of the optically-based systems cannot be used with opaque containers, and many of the mechanically-based systems cannot be attached to the containers or otherwise used in certain situations.

Moreover, in the case of existing automated systems, where there are a number of liquid containers, a separate automated system must be associated with each container. As can be appreciated, the need for a plurality of automated systems to handle a corresponding plurality of liquid containers can quickly lead to considerable expense.

### SUMMARY OF THE INVENTION

It is an object of the present invention to provide a novel system for determining the level of a liquid in a container.

It is another object of the present invention to provide a system as described above that overcomes at least some of the shortcomings associated with existing systems for determining the level of a liquid in a container.

According to one aspect of the invention, there is provided a system for determining the level of a liquid in a container, the system comprising (a) a first fluid conduit, the first fluid conduit comprising a distal end and a first proximal end, the first fluid conduit being appropriately dimensioned so that, when the distal end is inserted into the container and is situated proximate to the bottom of the container, the first proximal end is situated outside of the container; (b) a pressure transducer, the pressure transducer being operatively coupled to the first proximal end of the first fluid conduit so as to emit a signal proportional in amplitude to the fluid pressure head in the container; (c) a processor operatively coupled to the pressure transducer to receive the signal emitted by the pressure transducer and to determine the liquid level in the container based on the signal; and (d) a display operatively coupled to the processor to display the determined liquid level in the container.

In another, more detailed feature of the invention, the first fluid conduit may be dimensioned so that, when the distal end is inserted into the container and is situated proximate to the bottom of the container, the first proximal end may be positioned outside the container at least one foot away.

In another, more detailed feature of the invention, the first fluid conduit may further comprise a second proximal end, and the system may further comprise a check valve and a gas displacement device. The check valve may comprise a first end and a second end, the first end of the check valve may be operatively coupled to the second proximal end of the first fluid conduit, and the second end of the check valve may be operatively coupled to the gas displacement device.

In another, more detailed feature of the invention, the display may comprise at least one of a bar graph array and a digital display.

In another, more detailed feature of the invention, the display may comprise a bar graph array.

In another, more detailed feature of the invention, the system may further comprise a printed circuit board, and each of the pressure transducer, the processor, and the display may be coupled to the printed circuit board.

In another, more detailed feature of the invention, the processor and the display may be connected wirelessly.

According to another aspect of the invention, there is provided a system for determining the level of a liquid in a container, the system comprising (a) a first fluid conduit, the first fluid conduit comprising a distal end and a first proximal end, the first fluid conduit being appropriately dimensioned so that, when the distal end is inserted into the container and is situated proximate to the bottom of the container, the first proximal end is situated outside of the container; (b) a pressure transducer, the pressure transducer being operatively coupled to the first proximal end of the first fluid conduit so as to emit a signal proportional in amplitude to the fluid pressure head in the container; (c) a processor operatively coupled to the pressure transducer to receive the signal emitted by the pressure transducer and to determine the liquid level in the container based on the signal; and (d) a user interface module operatively coupled to the processor, the user interface module comprising at least one user-accessible input control and at least one user-perceptible notification device.

In another, more detailed feature of the invention, the at least one user-accessible input control may comprise at least one of a sampling frequency control for adjusting the frequency at which liquid level measurements are processed by the processor and at least one calibration control for use in calibrating the processor.

In another, more detailed feature of the invention, the at least one user-perceptible notification device may comprise at least one of at least one visual notification device and at least one audible notification devices.

In another, more detailed feature of the invention, the at least one visual notification device may comprise at least one of a bar graph array and a digital display.

According to another aspect of the invention, there is provided a system for determining the level of a liquid in one or more of a plurality of containers, the system comprising (a) a plurality of fluid conduits, each of the fluid conduits comprising a distal end and a first proximal end and being appropriately dimensioned so that, when the distal end is inserted into a container and is situated proximate to the bottom of the container, the first proximal end is situated outside of the container; (b) a corresponding plurality of pressure transducers, each of the pressure transducers being operatively coupled to the first proximal end of a different one of the fluid conduits so as to emit a signal proportional in amplitude to the fluid pressure head in a corresponding container; (c) a processor operatively coupled to the pressure transducers to receive the signals emitted by the pressure transducers and to determine the liquid level in the containers based on the signals; and (d) a user interface module operatively coupled to the processor, the user interface module comprising at least one user-perceptible notification device for communicating the liquid level in at least one of the containers.

In another, more detailed feature of the invention, the system may further comprise a printed circuit board, and each of the pressure transducers, the processor and the user interface module may be coupled to the printed circuit board.

In another, more detailed feature of the invention, the user interface module and the processor may be connected wirelessly.

In another, more detailed feature of the invention, the user interface module may comprise a graphical user interface on a computer.

In another, more detailed feature of the invention, the user interface module may further comprise a channel selection control for selecting a desired one of the containers to be analyzed for liquid level.

According to another aspect of the invention, there is provided a system for determining the level of a liquid in one or more of a plurality of containers, the system comprising (a) a plurality of fluid conduits, each of the fluid conduits comprising a distal end and a first proximal end and being appropriately dimensioned so that, when the distal end is inserted into a container and is situated proximate to the bottom of the container, the first proximal end is situated outside of the container; (b) a valve assembly, the valve assembly comprising an output port and a plurality of input ports, each of the plurality of fluid conduits being operatively coupled to a different input port, the output port being selectively fluidly connectable to one of the input ports; (c) a pressure transducer, the pressure transducer being operatively coupled to the output port of the valve assembly so as to emit a signal proportional in amplitude to the fluid pressure head in a corresponding container fluidly coupled thereto; (d) a processor operatively coupled to the pressure transducer to receive the signal emitted by the pressure transducer and to determine the liquid level in a container based on the signal; and (e) a user interface module operatively coupled to the processor, the user interface module comprising at least one user-perceptible notification device for communicating the liquid level in at least one of the containers.

In another, more detailed feature of the invention, the user interface module and the processor may be connected wirelessly.

In another, more detailed feature of the invention, the user interface module may comprise a graphical user interface on a computer.

In another, more detailed feature of the invention, the user interface module may further comprise a channel selection control for selecting a desired one of the containers to be analyzed for liquid level.

In another, more detailed feature of the invention, the system may further comprise a printed circuit board, and each of the pressure transducers, the processor and the user interface module may be coupled to the printed circuit board.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a simplified schematic diagram of a first embodiment of a system constructed according to the present invention for determining the liquid level in a container, the system being shown, for illustrative purposes, together with an exemplary container containing a quantity of a liquid;

FIG. 2 is a side view of the system of FIG. 1, the system being shown, for illustrative purposes, together with an exemplary container containing a quantity of a liquid;

FIG. 3 is a simplified schematic diagram of a second embodiment of a system constructed according to the present invention for determining the liquid level in a container, the system being shown, for illustrative purposes, together with an exemplary container containing a quantity of a liquid;

FIG. 4 is a simplified schematic diagram of a third embodiment of a system constructed according to the present invention for determining the liquid level in a container, the system being configured for use with a plurality of containers, each container containing a quantity of a liquid;

FIG. 5 is a side view of the system of FIG. 4, the system being shown, for illustrative purposes, together with an exemplary plurality of containers, each container containing a quantity of a liquid;

FIG. 6 is a simplified schematic diagram of a fourth embodiment of a system constructed according to the present invention for determining the liquid level in a container, the system being configured for use with a plurality of containers, each container containing a quantity of a liquid; and

FIG. 7 is a simplified schematic diagram of a fifth embodiment of a system constructed according to the present invention for determining the liquid level in a container, the system being configured for use with a plurality of containers, each container containing a quantity of a liquid.

### DETAILED DESCRIPTION OF THE INVENTION

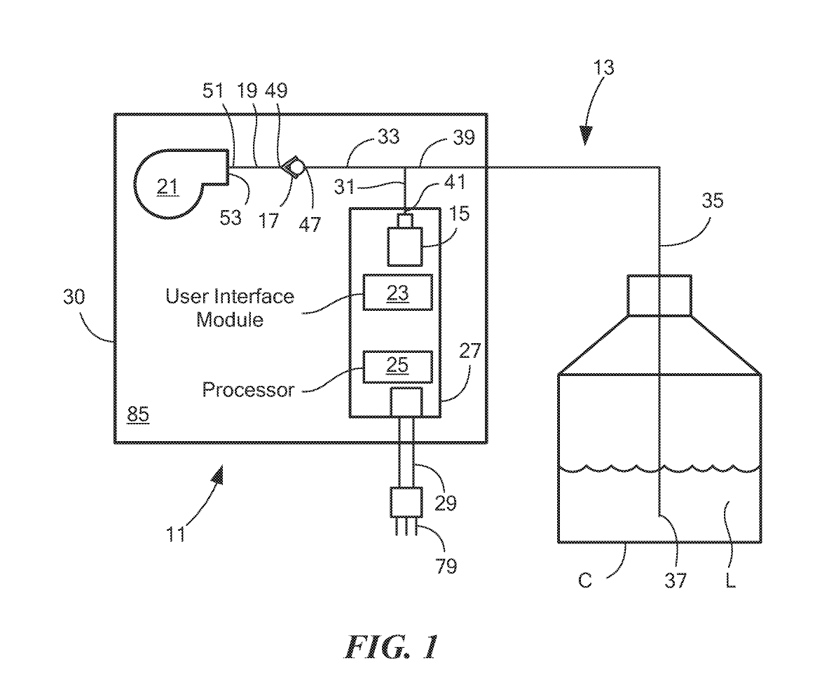

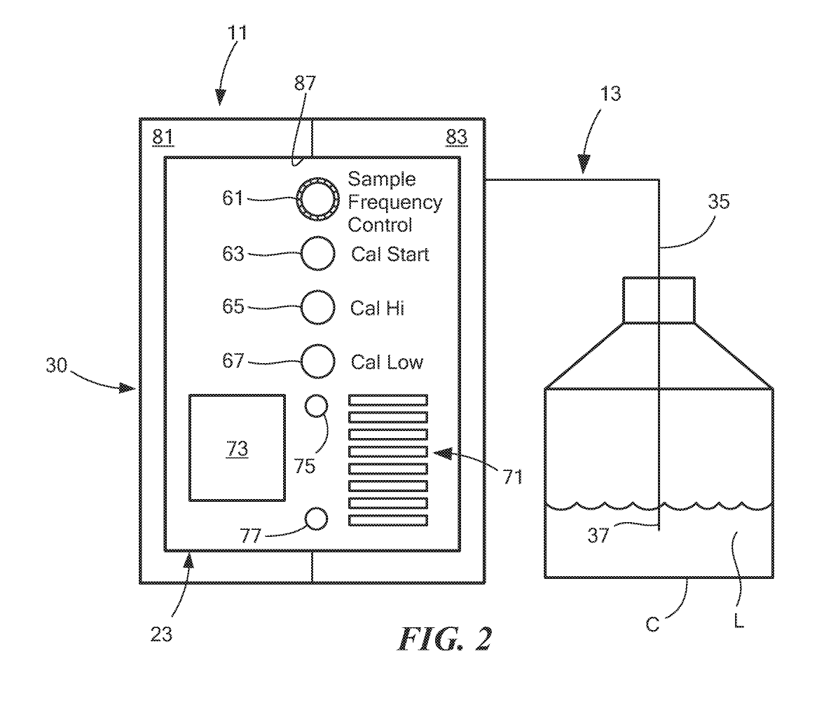

Referring now to FIGS. 1 and 2, there are shown a simplified schematic diagram and a side view of a first embodiment of a system constructed according to the present invention for determining the liquid level in a container, the system being represented generally by reference numeral 11. For illustrative purposes, system 11 is shown together with a container C containing a quantity of a liquid L.

System 11 may comprise a first fluid conduit 13, a pressure transducer 15, a check valve 17, a second fluid conduit 19, a gas displacement device 21, a user interface module 23, a processor 25, a printed circuit board 27, a power supply 29, and a housing 30.

First fluid conduit 13 may be a flexible or rigid unitary tubular member made of a chemically-inert, non-porous, gas-impermeable material, such as a suitable polymer or stainless steel. First fluid conduit 13 may be branched proximate to its proximal end to yield a first proximal branch 31, a second proximal branch 33, and a distal branch 35. Distal branch 35 of first fluid conduit 13 may have a suitable length such that its distal end 37 may be positioned inside a container, preferably near the bottom or at the bottom of the interior of the container, while its proximal end 39 may be located outside the container at a location that may be remote relative to the container, such as at least several inches away from the container and, in some cases, at least one or more feet away from the container and perhaps even at least dozens of feet away from the container. In this manner, all of the other components of system 11, including all of the electrical components of system 11, may be kept remote and/or isolated from the container, such as in a cabinet or even in another room. The maximum workable length of first fluid conduit 13, as measured from a proximal end 41 of first proximal branch 31 to distal end 37 of distal branch 35, may depend, in part, on the sensitivity of pressure transducer 15 and, in part, on the inner diameter of first fluid conduit 13. In general, the greater the inner diameter of first fluid conduit 13, the longer the maximum workable length. According to one embodiment, first fluid conduit 13 may comprise TYGON E-3603 flexible tubing (Saint-Gobain, Charny, France) and may have an inner diameter of approximately 3/32 inch and a length, as measured from proximal end 41 of first proximal branch 31 to distal end 37 of distal branch 35, of approximately 80 feet.

Pressure transducer 15, which may be a conventional pressure transducer, preferably of high sensitivity, may be operatively coupled to proximal end 41 of first proximal branch 31 in such a way as to sense the fluid pressure head of a container into which distal end 37 of distal branch 35 has been inserted and to emit an electrical signal proportional in amplitude to the magnitude of the fluid pressure head sensed thereby.

Check valve 17, which may be a conventional one-way check valve, such as a one-way ball check valve, may be operatively coupled at one end to a proximal end 47 of second proximal branch 33 and may be operatively coupled at an opposite end to a distal end 49 of second fluid conduit 19. Check valve 17 may serve to prevent a loss of the fluid pressure head via the leakage of air proximally from first fluid conduit 13 through second fluid conduit 19 and gas displacement device 21.

Second fluid conduit 19 may be a flexible or rigid unitary tubular member made of a chemically-inert, non-porous, gas-impermeable material, such as a suitable polymer or stainless steel. Second fluid conduit 19 may be made of the same material as first fluid conduit 13 but need not be. A proximal end 51 of second fluid conduit 19 may be operatively coupled to an output end 53 of gas displacement device 21.

Gas displacement device 21 may be a conventional air blower, air pump, fan, a compressed inert gas with a valve arrangement, or any other type of device that may be used to move air or another suitable gas. Gas displacement device 21 may be, but need not be, electrically powered. As will be discussed further below, gas displacement device 21 may be used, prior to each liquid level measurement, to blow air or an inert gas through secondary fluid conduit 19, check valve 17, second proximal branch 33, and distal branch 35, thereby clearing any debris from distal end 37 of distal branch 35 that may interfere with the measurement of the fluid pressure head. If desired, a particulate filter (not shown) may be positioned downstream of gas displacement device 21 to remove particulate matter from the output stream of gas displacement device 21.

User interface module 23 may comprise one or more user-accessible input controls and one or more user-perceptible notification devices. For example, the one or more user-accessible input controls may comprise a sampling frequency control 61 for adjusting the frequency at which liquid level measurements are analyzed by processor 25, a calibration start control 63 for directing processor 25 to initiate the calibration procedure for liquid L in container C, a calibration high control 65 for directing processor 25 to take a calibrating measurement when the level of liquid L in container C is at a desired maximum level, and a calibration low control 67 for directing processor 25 to take a calibrating measurement when the level of liquid L in container C is at a desired minimum level, which may or may not be when container C is empty. As can be appreciated, sampling frequency control 61 may be omitted if one does not wish to vary the sampling frequency, and calibration start control 63, calibration high control 65 and calibration low control 67 may be omitted if one wishes to calibrate through firmware on processor 25.

The one or more user-perceptible notification devices of user interface module 23 may comprise one or more visual or audible notification devices. Examples of visual notification devices may comprise one or more of a bar graph array 71 for depicting, through lighted segments, the level of liquid L in container C relative to the calibrated maximum and minimum levels, a digital display 73 for depicting numerically the percentage of liquid L present in container C relative to the calibrated maximum and minimum levels, an illuminable high level alert 75, which may be, for example, an LED, for indicating when the determined level exceeds a certain set point level, which may be at the maximum level or near the maximum level (90%), and an illuminable low level alert 77, which may be, for example an LED, for indicating when the level drops below a certain level set point, which may be at the minimum or near the minimum (e.g., 10% full). Other types of visual notification devices may include a high resolution display illustrating a bottle-type icon with a depiction of a liquid level therein. Such an icon may be accompanied by a percent full/level number. Examples of audible notification devices may comprise audible alarms for indicating when the level exceeds the maximum level or drops below a certain level set point.

Processor 25 may be operatively coupled to pressure transducer 15 and may be equipped with appropriate firmware to measure and to process the signals emitted from pressure transducer 15. Because the mathematical relationship between the fluid pressure head and the liquid level height in a container is linear, once processor 25 has the calibrated values for the maximum and minimum levels, any signal from pressure transducer 15 can be converted by processor 25 into a liquid level reading by comparing the sensed fluid pressure head reading to the calibrated maximum and minimum level values.

Processor 25 may also be operatively coupled to user interface module 23 so that the one or more user-accessible input controls of user interface module 23 may be used to control the operation of processor 25 and so that the one or more user-perceptible notification devices of user interface module 23 may be controlled by processor 25.

Processor 25 may additionally be operatively coupled to gas displacement device 21 so that processor 25 may control the actuation of gas displacement device 21.

Pressure transducer 15, user interface module 23 and processor 25 may be mounted on or otherwise coupled to printed circuit board 27. Printed circuit board 27, which may be a one-sided board or a two-sided board, may include a conductive trace for connecting processor 25 to each of pressure transducer 15 and user interface module 23 in the manner described above.

Power supply 29, which may be coupled to those components of system 11 that require electrical power, may comprise a rechargeable or non-rechargeable battery mounted on or otherwise coupled to printed circuit board 27. Alternatively, and as shown in the present embodiment, power supply 29 may comprise a low voltage wall plug type transformer, which may be mounted on or otherwise coupled to printed circuit board 27 and which may comprise a plug 79 adapted to be plugged into a convention AC wall outlet. If installed in a NEMA-type enclosure or DIN rail arrangement, an appropriate voltage terminal may be used in lieu of the aforementioned wall transformer.

Housing 30 may comprise a first portion 81 and a second portion 83, each of which may be made of a rigid, durable material, such as a suitable polymer. First portion 81 and second portion 83 may be joined together by suitable means (not shown), such as screws, adhesives, and/or welding, to define a cavity 85. Cavity 85 may be appropriately dimensioned to accommodate all of the components of system 11, except for at least the distal portion of distal branch 35 of first fluid conduit 13. Housing 30 may be shaped to include a window 87 through which user interface module 23 may be accessible.

Although not shown, one or more visual or audible notification devices of user interface module 23 may be located remotely and externally to housing 30 and may be coupled to processor 25 through an output connector coupled to printed circuit board 27 through one or more relays.

In use, one may first calibrate system 11. This may be done, for example, by inserting distal end 37 of distal branch 35 into an empty container of the type to be used or by positioning distal end 37 of distal branch 35 above the liquid level of such a container containing liquid. Next, one may initiate the calibration procedure of system 11 by actuating calibration start control 63 and then actuating calibration low control 67, causing processor 25 to take a fluid pressure head reading from pressure transducer 15. Just prior to said reading being taken, gas displacement device 21 may cause air or a gas to be blown or expelled therefrom, thereby clearing any debris from distal branch 35. Next, one may position distal end 37 of distal branch 35 at or near the bottom of the same type of container containing a maximum desired quantity of the particular type of liquid to be monitored and then may actuate calibration high control 65, causing processor 25 to take a fluid pressure head reading form pressure transducer 15. Again, just prior to said reading being taken, gas displacement device 21 may cause air or a gas to be blown or expelled therefrom, thereby clearing any debris from distal branch 35. As can be appreciated, the order of the calibration high and calibration low readings may be taken in the reverse order from that disclosed above. Because there is a linear relationship between fluid pressure head and liquid level, the aforementioned high and low readings may be used by processor 25 to convert any future fluid pressure readings into liquid level readings.

With system 11 thus calibrated, one may use sampling frequency control 61 to select the frequency with which readings are to be taken. At whichever frequency is selected, gas displacement device 21 may clear debris from distal branch 35, and a fluid pressure head reading from pressure transducer 15 may be sent to processor 25. Processor 25 may compare the measured value to the calibrated values and, thereby, determine the liquid level. (If desired, a plurality of measured values taken over a short time span may be averaged and the average then used to determine the liquid level.) This information may then be transmitted from processor 25 to user interface module 23, where it may be communicated visually and/or audibly by user interface module 23.

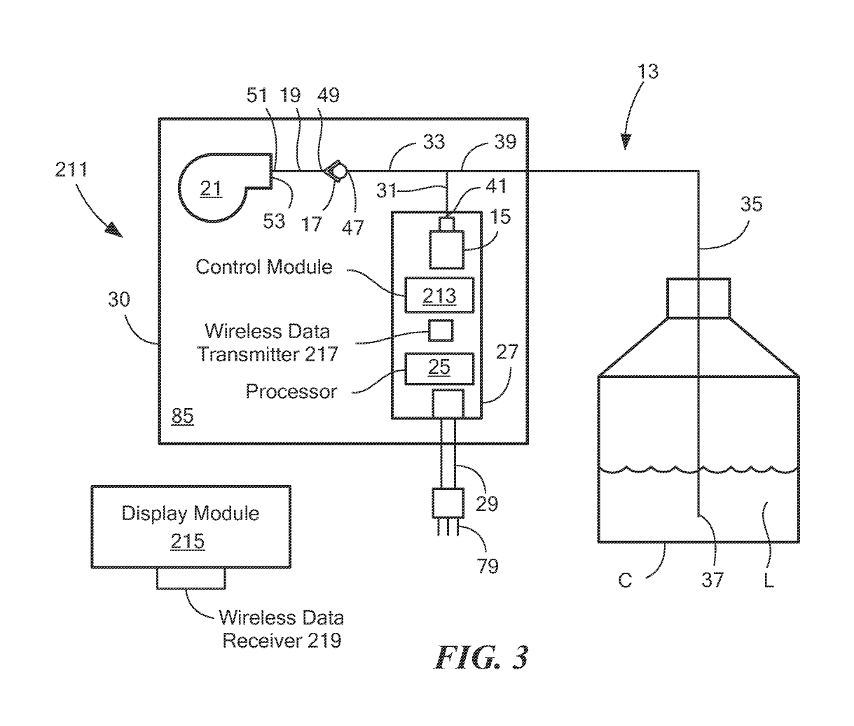

Referring now to FIG. 3, there is shown a simplified schematic diagram of a second embodiment of a system constructed according to the present invention for determining the liquid level in a container, the system being represented generally by reference numeral 211. For illustrative purposes, system 211 is shown together with container C containing a quantity of liquid L.

System 211 may be similar in most respects to system 11, a principal difference between the two systems being that, whereas system 11 may comprise a user interface module 23, system 211 may instead comprise a control module 213, a display module 215, a wireless data transmitter 217, and a wireless data receiver 219.

Control module 213 of system 211 may comprise one or more of the user-accessible input controls of user interface module 23. Control module 213 may be associated with a housing 221 in much the same way that user interface module 23 is associated with housing 30. Display module 215 may comprise one or more user-perceptible notification devices of user interface module 23. Display module 215 may be externally and remotely located relative to housing 221. Wireless data transmitter 217 may be associated with housing 221 and may be coupled to processor 25 whereas wireless data receiver 219 may be externally and remotely located relative to housing 221 and may be coupled to display module 215.

System 211 may be used in much the same fashion as system 11, except that wireless data transmitter 217 and wireless data receiver 219 enable display module 215 to be positioned remotely relative to housing 221.

As can readily be appreciated, system 211 may be modified so that, instead of having processor 25 communicate wirelessly with display module 215, display module 215 may be coupled to processor 25 through the combination of an output connector operatively coupled to printed circuit board 29 and a cable.

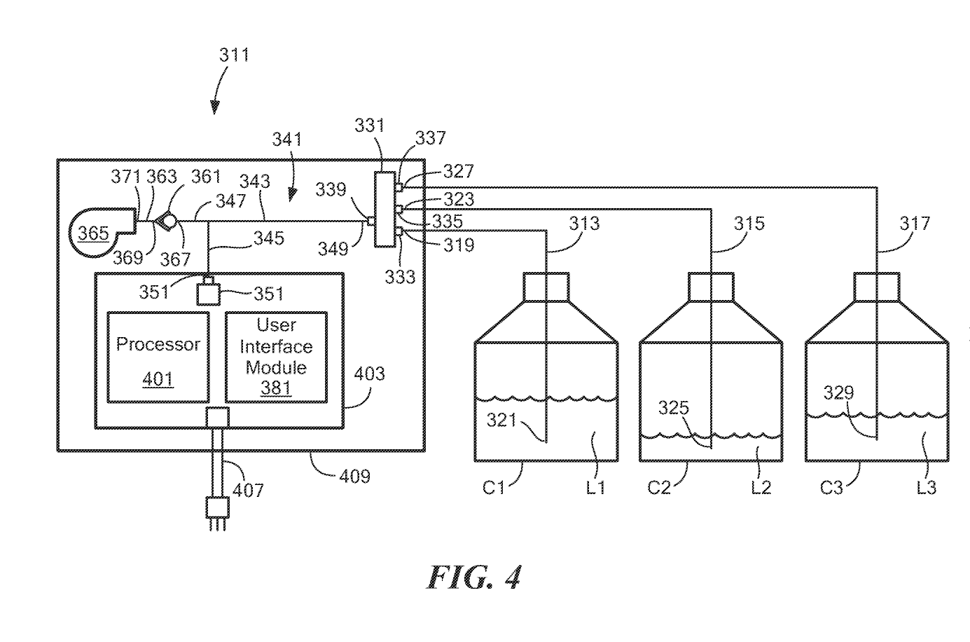

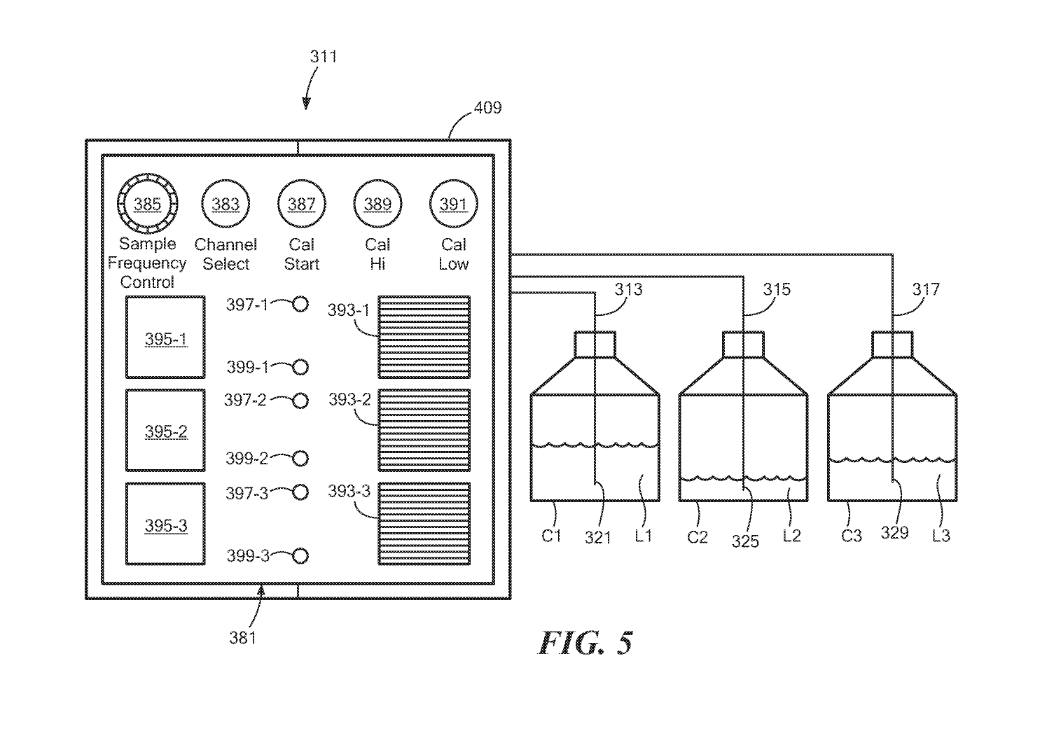

Referring now to FIGS. 4 and 5, there are shown a simplified schematic diagram and a side view of a third embodiment of a system constructed according to the present invention for determining the liquid level in a container, the system being represented generally by reference numeral 311. For illustrative purposes, system 311 is shown together with a plurality of containers, each container containing a quantity of a liquid. A first container C1 contains a quantity of a liquid L1, a second container C2 contains a quantity of a liquid L2, and a third container C3 contains a quantity of a liquid L3. Containers C1, C2 and C3 may be the same type of container or may be different types of containers, liquids L1, L2, and L3 may be the same type of liquid or may be different types of liquid, and the quantities of liquids L1, L2 and L3 in containers C1, C2, and C3, respectively, at any given time, may be the same quantities or may be different quantities.

System 311 may comprise a first fluid conduit 313, a second fluid conduit 315, and a third fluid conduit 317. Each of first fluid conduit 313, second fluid conduit 315, and third fluid conduit 317 may be similar in size and construction to distal branch 35 of system 11. First fluid conduit 313, which may comprise a proximal end 319 and a distal end 321, may have distal end 321 positioned inside container C1, preferably near the bottom or at the bottom of the interior of container C1, while proximal end 319 may be located outside container C1 at a location that may be remote relative to container C1. Second fluid conduit 315, which may comprise a proximal end 323 and a distal end 325, may have distal end 325 positioned inside container C2, preferably near the bottom or at the bottom of the interior of container C2, while proximal end 323 may be located outside container C2 at a location that may be remote relative to container C2. Third fluid conduit 317, which may comprise a proximal end 327 and a distal end 329, may have distal end 329 positioned inside container C3, preferably near the bottom or at the bottom of the interior of container C3, while proximal end 327 may be located outside container C3 at a location that may be remote relative to container C3.

System 311 may also comprise a valve assembly 331. Valve assembly 331 may include three input ports 333, 335, and 337 and one output port 339 and may be constructed so that fluid connection between output port 339 and any one of input ports 333, 335, and 337 may be selectively made. Proximal end 319 of first fluid conduit 313 may be operatively coupled to input port 333, proximal end 323 of second fluid conduit 315 may be operatively coupled to input port 335, and proximal end 327 of third fluid conduit 317 may be operatively coupled to input port 337.

System 311 may further comprise a fourth fluid conduit 341. Fourth fluid conduit 341 may be similar in construction to first fluid conduit 13 of system 11, albeit possibly shorter in length, and may be branched to yield a distal branch 343, a first proximal branch 345, and a second proximal branch 347. A distal end 349 of distal branch 343 may be operatively coupled to output port 339 of valve assembly 331.

System 311 may further comprise a pressure transducer 351, which may be similar to pressure transducer 15 of system 11. Pressure transducer 351 may be operatively coupled to a proximal end 351 of first proximal branch 345.

System 311 may further comprise a check valve 361, a fifth fluid conduit 363, and a gas displacement device 365. Check valve 361, which may be similar to check valve 17 of system 11, may be operatively coupled at one end to a proximal end 367 of second proximal branch 347 and may be operatively coupled at an opposite end to a distal end 369 of fifth fluid conduit 363. Fifth fluid conduit 363, which may be similar to second fluid conduit 19 of system 11, may be coupled at a proximal end 371 to gas displacement device 365. Gas displacement device 365 may be similar to gas displacement device 21 of system 11. If desired, a particulate filter (not shown) may be positioned downstream of gas displacement device 365 to remove particulate matter from the output stream of gas displacement device 365.

System 311 may further comprise a user interface module 381. User interface module 381 may comprise one or more user-accessible input controls and one or more user-perceptible notification devices. For example, the one or more user-accessible input controls may comprise a channel selection control 383 for selecting a desired one of containers C1, C2 and C3 to be calibrated and/or analyzed in terms of liquid level, a sampling frequency control 385 for adjusting the frequency at which liquid level measurements are to be analyzed, a calibration start control 387 for initiating the calibration procedure for a selected container, a calibration high control 389 for causing a calibrating measurement to be taken when the liquid level in the selected container is at a desired maximum level, and a calibration low control 391 for causing a calibrating measurement to be taken when the liquid level in the selected container is at a desired minimum level, which may or may not be when the container is empty. As can be appreciated, sampling frequency control 385 may be omitted if one does not wish to vary the sampling frequency, and calibration start control 387, calibration high control 389 and calibration low control 391 may be omitted if one wishes to calibrate through firmware on the system processor.

The one or more user-perceptible notification devices of user interface module 381 may comprise one or more visual or audible notification devices. Examples of visual notification devices may comprise one or more of bar graph arrays 393-1, 393-2, and 393-3 for depicting, through lighted segments, the liquid levels in containers C1 through C3, respectively, digital displays 395-1 through 395-3 for depicting numerically the liquid levels in containers C1 through C3, respectively, expressed as percentages relative to the calibrated maximum and minimum levels, illuminable high level alerts 397-1 through 397-3, which may be, for example, LEDs, for indicating when the liquid levels in containers C1 through C3, respectively, exceed a certain set point level, which may be at the maximum level or near the maximum level (90%), and illuminable low level alerts 399-1 through 399-3, which may be, for example LEDs, for indicating when the liquid levels in containers C1 through C3, respectively, drop below a certain level set point, which may be at the minimum or near the minimum (e.g., 10% full). As can be appreciated, instead of including a plurality of bar graph arrays 393-1 through 393-3, a plurality of digital displays 395-1 through 395-3, a plurality of high level alerts 397-1 through 397-3, and/or a plurality of low level alerts 399-1 through 399-3, user interface module 381 may instead comprise a single bar graph array, digital display, etc., together with an indicator that conveys which container the results represent. Examples of audible notification devices may comprise audible alarms for indicating when the liquid level exceeds the maximum level or drops below a certain level set point.

System 311 may further comprise a processor 401, which may be operatively coupled to pressure transducer 351 and may be equipped with appropriate firmware to measure and to process the signals emitted from pressure transducer 351. Processor 401 may also be operatively coupled to user interface module 381 so that the one or more user-accessible input controls of user interface module 381 may be used to control the operation of processor 351 and so that the one or more user-perceptible notification devices of user interface module 351 may be controlled by processor 401. Processor 401 may additionally be operatively coupled to gas displacement device 365 so that processor 401 may control the actuation of gas displacement device 365.

Pressure transducer 351, user interface module 381 and processor 401 may be mounted on or otherwise coupled to a printed circuit board 403. Printed circuit board 403, which may be a one-sided board or a two-sided board, may include a conductive trace for connecting processor 401 to each of pressure transducer 351 and user interface module 381 in the manner described above.

System 311 may further comprise a power supply 407, which may be coupled to those components of system 311 that require electrical power. Power supply 407 may be similar to power supply 29 of system 11.

System 311 may further comprise a housing 409, which may be similar to housing 30 of system 11 and which may be used to accommodate all of the components of system 311, except for at least the distal portions of first fluid conduit 313, second fluid conduit 315 and third fluid conduit 317.

System 311 may be calibrated in much the same way as system 11, except that each of containers C1 through C3 may be calibrated independently or not, depending on whether the containers and the liquids contained therein are different or not. Channel selection control 383 may be used to select a particular container for calibration. Once system 311 has been calibrated, pressure transducer 351 may be fluidly connected sequentially to each of the containers via valve assembly 331 so that pressure transducer 351 may sense the fluid pressure head in each container and may emit a corresponding signal. The signals emitted by pressure transducer 351 may then be transmitted to processor 401, and a liquid level determination for each container may be made by processor 401. This information may then be sent to user interface module 381 to be communicated visually or audibly. This measuring procedure may be repeated at a desired frequency.

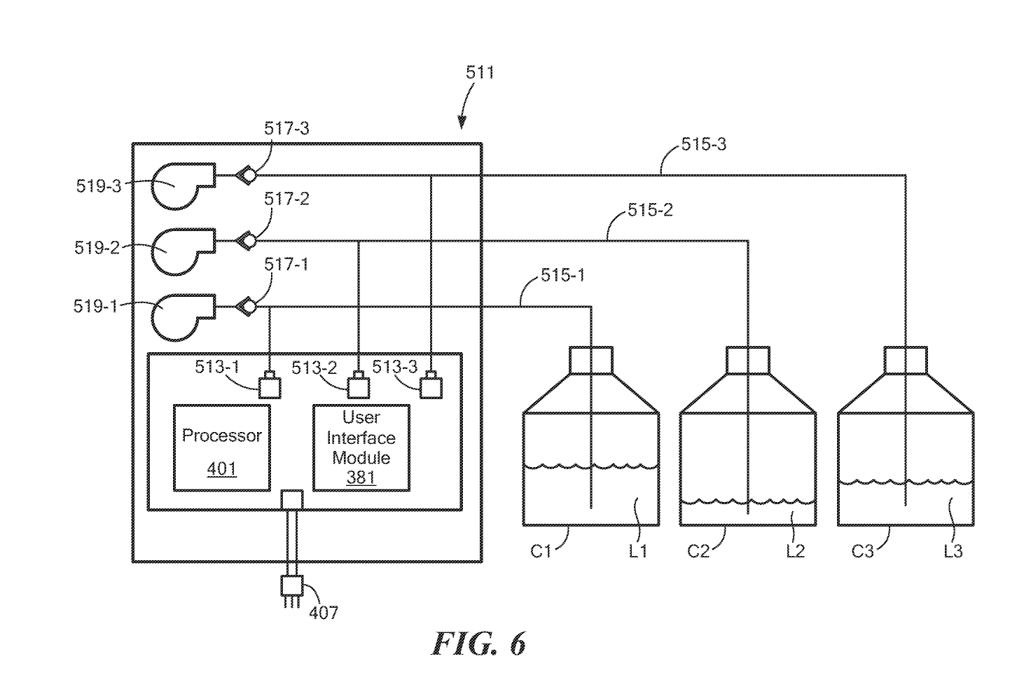

Referring now to FIG. 6, there is shown a simplified schematic diagram of a fourth embodiment of a system constructed according to the present invention for determining the liquid level in a container, the system being represented generally by reference numeral 511. For illustrative purposes, system 511 is shown together with a plurality of containers, each container containing a quantity of a liquid. A first container C1 contains a quantity of a liquid L1, a second container C2 contains a quantity of a liquid L2, and a third container C3 contains a quantity of a liquid L3. Containers C1, C2 and C3 may be the same type of container or may be different types of containers, liquids L1, L2, and L3 may be the same type of liquid or may be different types of liquid, and the quantities of liquids L1, L2 and L3 in containers C1, C2, and C3, respectively, at any given time, may be the same quantities or may be different quantities.

System 511 is similar in some respects to system 311, a principal difference between the two systems being that, whereas system 311 may comprise a single pressure transducer 351 that is selectively coupled to first fluid conduit 313, second fluid conduit 315, or third fluid conduit 317 through valve assembly 331, system 511 may omit such a valve assembly and may instead comprise a plurality of pressure transducers 513-1 through 513-3, wherein each of pressure transducers 513-1 through 513-3 is coupled to a different container C1 through C3, respectively, through its own fluid conduit 515-1 through 515-3, respectively. Another difference between the two systems may be that, whereas system 311 may comprise a single check valve 361 and a single gas displacement device 365, system 511 may comprise a plurality of check valves 517-1 through 517-3 and a plurality of gas displacement device 519-1 through 519-3, wherein each of check valves 517-1 through 517-3 is coupled at one end to a different gas displacement device 519-1 through 519-3, respectively, and wherein each of check valves 517-1 through 517-3 is coupled at another end to a different fluid conduit 515-1 through 515-3, respectively. Although not shown, a particulate filter may be positioned downstream of each of gas displacement devices 519-1 through 519-3 to remove particulate matter from the output streams of gas displacement devices 519-1 through 519-3.

System 511 may be used in much the same way as system 311, with a principal difference being that system 511 is configured so that a separate pressure transducer senses the fluid pressure head from each container, without requiring a valve assembly to switch the pressure transducer from one container to another.

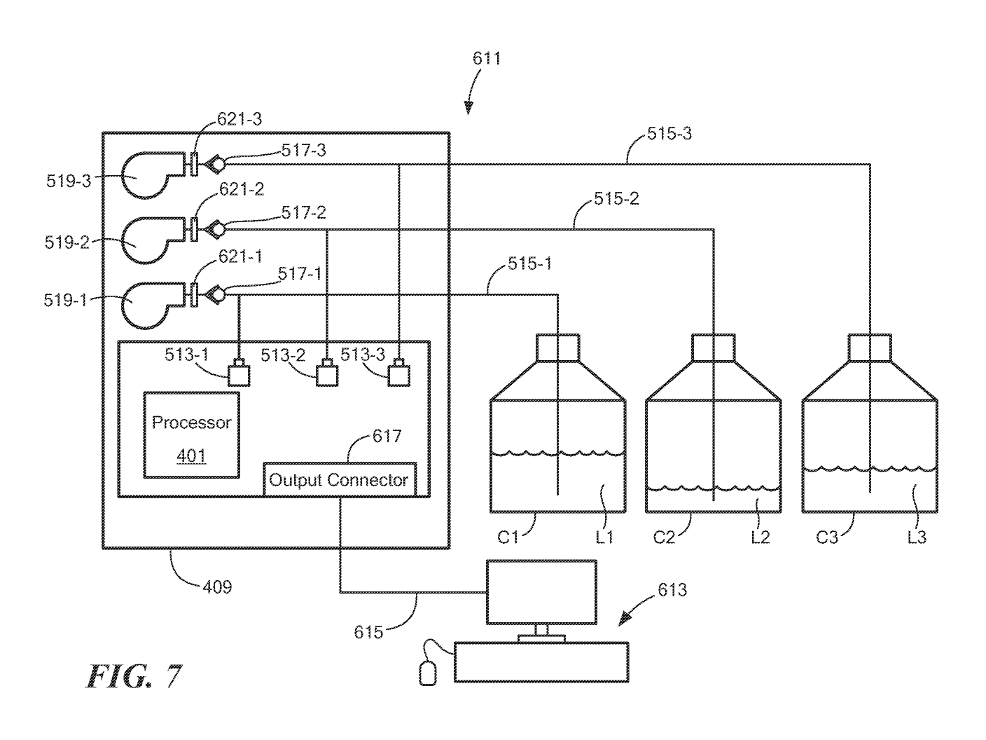

Referring now to FIG. 7, there is shown a simplified schematic diagram of a fifth embodiment of a system constructed according to the present invention for determining the liquid level in a container, the system being represented generally by reference numeral 611. For illustrative purposes, system 611 is shown together with a plurality of containers, each container containing a quantity of a liquid. A first container C1 contains a quantity of a liquid L1, a second container C2 contains a quantity of a liquid L2, and a third container C3 contains a quantity of a liquid L3. Containers C1, C2 and C3 may be the same type of container or may be different types of containers, liquids L1, L2, and L3 may be the same type of liquid or may be different types of liquid, and the quantities of liquids L1, L2 and L3 in containers C1, C2, and C3, respectively, at any given time, may be the same quantities or may be different quantities.

System 611 may be similar in most respects to system 511, a principal difference between the two systems being that, whereas system 511 may comprise user interface module 381 disposed within housing 409, system 611 may instead comprise a computer 613 externally located relative to housing 409, computer 613 being coupled to processor 401 via a cable 615 and an output connector 617. Computer 613 may be equipped with a graphical user interface that may be configured to provide input controls and notification devices analogous to those that may be present in user interface module 381.

System 611 may further comprise a plurality of a plurality of particulate filters 621-1 through 621-3, a different such particulate filter 621-1 through 621-3 being positioned downstream of each of gas displacement devices 519-1 through 519-3.

It should be understood that the variations discussed above in the context of single-container systems, such as systems 11 and 211, may be applied to multi-container systems, such as systems 311, 511 and 611, and vice versa. For example, the multi-container systems disclosed herein may be modified for wireless transmission of the determined liquid levels to a remote location. In corresponding fashion, the single-container systems disclosed herein may be modified for integration with a computer.

Some of the positive attributes of the system of the present invention are that it is rugged and reliable, it includes a minimal number of parts, it is easy to calibrate and to use, and it can be used with opaque containers and in hazardous environments where electrical components are not permitted to be present. In addition, certain embodiments of the invention are adapted to measure the liquid level of a plurality of containers.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for determining the level of a liquid in a container, the system comprising:
(a) a first fluid conduit, the first fluid conduit comprising a distal end and a first proximal end, the first fluid conduit being appropriately dimensioned so that, when the distal end is inserted into the container and is situated proximate to the bottom of the container, the first proximal end is situated outside of the container;
(b) a pressure transducer, the pressure transducer being operatively coupled to the first proximal end of the first fluid conduit so as to emit a signal proportional in amplitude to the fluid pressure head in the container;
(c) a processor operatively coupled to the pressure transducer to receive the signal emitted by the pressure transducer and to determine the liquid level in the container based on the signal; and
(d) a display operatively coupled to the processor to display the determined liquid level in the container.

2. The system as claimed in claim 1 wherein the first fluid conduit is dimensioned so that, when the distal end is inserted into the container and is situated proximate to the bottom of the container, the first proximal end is positioned outside the container at least one foot away.

3. The system as claimed in claim 1 wherein the first fluid conduit further comprises a second proximal end, the system further comprising a check valve and a gas displacement device, the check valve comprising a first end and a second end, the first end of the check valve being operatively coupled to the second proximal end of the first fluid conduit, the second end of the check valve being operatively coupled to the gas displacement device.

4. The system as claimed in claim 1 wherein the display comprises at least one of a bar graph array and a digital display.

5. The system as claimed in claim 4 wherein the display comprises a bar graph array.

6. The system as claimed in claim 1 further comprising a printed circuit board, each of the pressure transducer, the processor, and the display being coupled to the printed circuit board.

7. The system as claimed in claim 1 wherein the processor and the display are connected wirelessly.

8. A system for determining the level of a liquid in a container, the system comprising:
(a) a first fluid conduit, the first fluid conduit comprising a distal end and a first proximal end, the first fluid conduit being appropriately dimensioned so that, when the distal end is inserted into the container and is situated proximate to the bottom of the container, the first proximal end is situated outside of the container;
(b) a pressure transducer, the pressure transducer being operatively coupled to the first proximal end of the first fluid conduit so as to emit a signal proportional in amplitude to the fluid pressure head in the container;
(c) a processor operatively coupled to the pressure transducer to receive the signal emitted by the pressure transducer and to determine the liquid level in the container based on the signal; and
(d) a user interface module operatively coupled to the processor, the user interface module comprising at least one user-accessible input control and at least one user-perceptible notification device.

9. The system as claimed in claim 8 wherein the at least one user-accessible input control comprises at least one of a sampling frequency control for adjusting the frequency at which liquid level measurements are processed by the processor and at least one calibration control for use in calibrating the processor.

10. The system as claimed in claim 8 wherein the at least one user-perceptible notification device comprises at least one of at least one visual notification device and at least one audible notification devices.

11. The system as claimed in claim 10 wherein the at least one visual notification device comprises at least one of a bar graph array and a digital display.

12. A system for determining the level of a liquid in one or more of a plurality of containers, the system comprising:
(a) a plurality of fluid conduits, each of the fluid conduits comprising a distal end and a first proximal end and being appropriately dimensioned so that, when the distal end is inserted into a container and is situated proximate to the bottom of the container, the first proximal end is situated outside of the container;
(b) a corresponding plurality of pressure transducers, each of the pressure transducers being operatively coupled to the first proximal end of a different one of the fluid conduits so as to emit a signal proportional in amplitude to the fluid pressure head in a corresponding container;
(c) a processor operatively coupled to the pressure transducers to receive the signals emitted by the pressure transducers and to determine the liquid level in the containers based on the signals; and
(d) a user interface module operatively coupled to the processor, the user interface module comprising at least one user-perceptible notification device for communicating the liquid level in at least one of the containers.

13. The system as claimed in claim 12 further comprising a printed circuit board and wherein each of the pressure transducers, the processor and the user interface module is coupled to the printed circuit board.

14. The system as claimed in claim 12 wherein the user interface module and the processor are connected wirelessly.

15. The system as claimed in claim 12 wherein the user interface module comprises a graphical user interface on a computer.

16. The system as claimed in claim 12 wherein the user interface module further comprises a channel selection control for selecting a desired one of the containers to be analyzed for liquid level.

17. A system for determining the level of a liquid in one or more of a plurality of containers, the system comprising:
(a) a plurality of fluid conduits, each of the fluid conduits comprising a distal end and a first proximal end and being appropriately dimensioned so that, when the distal end is inserted into a container and is situated proximate to the bottom of the container, the first proximal end is situated outside of the container;
(b) a valve assembly, the valve assembly comprising an output port and a plurality of input ports, each of the plurality of fluid conduits being operatively coupled to a different input port, the output port being selectively fluidly connectable to one of the input ports;
(c) a pressure transducer, the pressure transducer being operatively coupled to the output port of the valve assembly so as to emit a signal proportional in amplitude to the fluid pressure head in a corresponding container fluidly coupled thereto;
(d) a processor operatively coupled to the pressure transducer to receive the signal emitted by the pressure transducer and to determine the liquid level in a container based on the signal; and
(e) a user interface module operatively coupled to the processor, the user interface module comprising at least one user-perceptible notification device for communicating the liquid level in at least one of the containers.

18. The system as claimed in claim 17 wherein the user interface module and the processor are connected wirelessly.

19. The system as claimed in claim 17 wherein the user interface module comprises a graphical user interface on a computer.

20. The system as claimed in claim 17 wherein the user interface module further comprises a channel selection control for selecting a desired one of the containers to be analyzed for liquid level.

21. The system as claimed in claim 17 further comprising a printed circuit board and wherein each of the pressure transducers, the processor and the user interface module is coupled to the printed circuit board.
